(19) United States
(12) Patent Application Publication
(10) Pub. No.: US 2025/0103724 A1
(43) Pub. Date: Mar. 27, 2025

(54) SYSTEMS AND METHODS FOR COORDINATING THREAT DETECTION AND MITIGATION AMONG A FLEET OF TRUSTED DEVICES

(71) Applicant: Xerox Corporation, Norwalk, CT (US)

(72) Inventors: Noah John David Ullmann, Rochester, NY (US); Lee C. Moore, Penfield, NY (US); Mark A. Sixbey, Rock Hill, SC (US)

(73) Assignee: Xerox Corporation, Norwalk, CT (US)

(21) Appl. No.: 18/473,696

(22) Filed: Sep. 25, 2023

(51) Int. Cl. G06F 21/57

(52) U.S. Cl. CPC G06F 21/577

(57) ABSTRACT

The present disclosure is directed to systems and methods of coordinating threat detection and mitigation among a fleet of trusted devices. As described herein, cybersecurity is a growing concern of many individuals and organizations, especially for those that use multiple electronic devices. In expansive computing environments such as these, security information and event management (SIEM) solutions have been developed. However, providing a holistic solution to a distributed environment remains challenging. According, the systems and methods described utilize an SIEM solution in conjunction with a threat response profile hosted locally on a trusted device within a fleet of trusted devices to provide a coordinated threat response that can be narrowly and/or broadly applied to one or more devices of the fleet of trusted devices.

### FIELD OF THE DISCLOSURE

The present disclosure relates generally to security threat detection and response processes involving a trusted fleet of multi-function devices, and more specifically to systems and methods for coordinating such threat detection and response processes using a trusted fleet of multi-function devices.

### BACKGROUND

Cybersecurity is a growing concern of many individuals and organizations. This is especially true for individuals and organizations that use or rely upon multiple electronic devices, each of which represents a potential vulnerability. In certain scenarios, for example, an organization may supply its employees with desktop computers, laptops, smartphones, and/or multi-function devices (such as multi-function printers), which can be used in a variety of locations and under a variety of conditions, thereby increasing the likelihood of encountering a cybersecurity-related threat. In order to detect and respond to these threats, many security information and event management (SIEM) solutions have been developed. Generally, these solutions incorporate aspects of security information management (SIM) for collecting and/or aggregating available information, with security event management (SEM) for detecting and responding to various threats.

While an individual or organization with a number of different electronic devices may wish to protect all of these devices, there exists serious practical and technical challenges to developing a cohesive and coordinated threat detection and mitigation strategy. For example, the SIEM solution of each organization may be customized to a particular environment or setup of devices, as well as the organization's specific needs, without considering how one affected device may (or should) impact the operation of one or more other devices. That is, in conventional systems, SIM and SEM tools at one device may not interact the SIM and SEM tools of other devices, such that threat responses are treated on a device-by-device basis. Further, even where these tools allow for some consideration of other devices, coordination and threat responses are limited because each device must be connected to the SIEM solution or some third-party response service.

### SUMMARY OF THE DISCLOSURE

According to an embodiment of the present disclosure, a computer-implemented method of coordinating threat detection and mitigation among a fleet of trusted devices is provided. The method may include: transmitting, from at least a first device of the fleet of trusted devices, an events report comprising log data from at least the first device of the fleet of trusted devices; receiving, at the first device of the fleet of trusted devices, one or more security-related messages generated based on an analysis of the events report; generating, via the first device of the fleet of trusted devices, a threat response based on the one or more security-related messages using a threat response profile; distributing, from the first device, the generated threat response to one or more other devices of the fleet of trusted devices via one or more trusted connections between the devices of the fleet of trusted devices; and for one or more of the other devices of the fleet of trusted devices, changing a device configuration setting for the device based on the threat response generated.

In an aspect, each trusted device of the fleet of trusted devices may be a multi-function printer.

In an aspect, the events report may be transmitted from at least the first device to a security information and event management system, and the one or more security-related messages may be received from the security information and event management system.

In an aspect, the method may further include: analyzing, via the security information and event management system, the events report transmitted from at least the first device to determine the one or more security-related messages.

In an aspect, the threat response may include one or more of the following: an instruction to communicate a warning; an instruction to disable a device; an instruction to disable a service; an instruction to re-route an assigned task to another device within the fleet of trusted devices; an instruction to change security settings; an instruction to change file integrity; an instruction to escalate the threat response; an instruction to alert an administrator; and an instruction to request additional information.

In an aspect, the threat response may include an instruction to disable one or more services of an affected device within the fleet of trusted devices without discontinuing one or more other services of the affected device.

In an aspect, the one or more services may include at least one of a printing service, a scanning service, a faxing service, a copying service, and a file sharing service.

In an aspect, the threat response may include (i) a first threat response for a first affected device of the fleet of trusted devices, and (ii) a second threat response for a second affected device of the fleet of trusted devices, wherein the first threat response is different from the second threat response.

In an aspect, the threat response generated using the threat response profile may include a device-specific response for each device of the fleet of trusted devices, wherein each device-specific response is customized based on a configuration of each device.

In an aspect, the log data of the events report may include one or more of the following: number of failed logins from a single device; number of firewall-related events from a single IP address; number of IDS alerts from a single IP address; and detection of identifiable malware.

In an aspect, the events report may include log data collected from one or more devices of the fleet of trusted devices in addition to log data collected from the first device of the fleet of trusted devices.

According to another embodiment of the present disclosure, a non-transitory computer-readable storage medium having stored thereon machine-readable instructions is provided. When executed by one or more processors, the machine-readable instructions cause the one or more processors to perform operations comprising: transmit, from at least a first device of a fleet of trusted devices, an events report comprising log data from at least the first device of the fleet of trusted devices; receive one or more security-related messages generated based on an analysis of the events report; generate a threat response based on the one or more security-related messages using a threat response profile; and distribute the generated threat response to one or more other devices of the fleet of trusted devices via one or more trusted connections between the devices of the fleet of trusted devices.

In an aspect, each trusted device of the fleet of trusted devices may be a multi-function printer.

In an aspect, the non-transitory computer-readable storage medium may further include machine-readable instructions that cause the one or more processors to: change a device configuration setting of one or more devices of the fleet of trusted devices based on the threat response generated.

In an aspect, the threat response may include one or more of the following: an instruction to communicate a warning; an instruction to disable a device; an instruction to disable a service; an instruction to re-route an assigned task to another device within the fleet of trusted devices; an instruction to change security settings; an instruction to change file integrity; an instruction to escalate the threat response; an instruction to alert an administrator; and an instruction to request additional information.

In an aspect, the threat response may include an instruction to disable one or more services of an affected device within the fleet of trusted devices without discontinuing one or more other services of the affected device.

In an aspect, the threat response may include (i) a first threat response for a first affected device of the fleet of trusted devices, and (ii) a second threat response for a second affected device of the fleet of trusted devices, wherein the first threat response is different from the second threat response.

In an aspect, the threat response generated using the threat response profile may include a device-specific response for each device of the fleet of trusted devices, and each device-specific response may be customized based on a configuration of each device.

According to yet another embodiment of the present disclosure, an electronic device configured to coordinate threat detection and mitigation within a fleet of trusted devices is provided. The electronic device may include: one or more processors; and a memory in communication with the one or more processors, wherein the memory comprises machine-readable instructions that, when executed by the one or more processors, cause the one or more processors to perform operations including the following: (i) generate and/or receive a threat response, wherein the threat response includes an instruction to change a device configuration setting for one or more devices within the fleet of trusted devices; (ii) distribute the threat response to one or more other devices within the fleet of trusted devices; and (iii) change a device configuration setting of the electronic device based on the threat response generated and/or received.

In an aspect, each trusted device of the fleet of trusted devices may be a multi-function printer.

In an aspect, the instruction to change a device configuration setting for one or more devices within the fleet of trusted devices may include an instruction to disable one or more services of an affected device within the fleet of trusted devices without discontinuing one or more other services of an unaffected device, the one or more services including at least one of a printing service, a scanning service, a faxing service, a copying service, and a file sharing service.

In an aspect, the memory further comprises machine-readable instructions that, when executed by the one or more processors, cause the one or more processors to perform operations including the following: transmit an events report to a security information and event management system, wherein the events report comprises log data from at least the electronic device; receive, from the security information and event management system, one or more security-related messages generated based on an analysis of the events report; and generate the threat response based on the one or more security-related messages using a threat response profile.

In an aspect, the electronic device may further include a threat response profile stored within the memory of the electronic device, wherein the threat response profile includes a plurality of rules for interpreting one or more security-related messages received from the security information and event management system and generating a threat response for one or more devices of the fleet of trusted devices.

In an aspect, the threat response may be received from at least a first device within the fleet of trusted devices via one or more trusted connections between the devices of the fleet of trusted devices.

These and other aspects of the various embodiments will be apparent from and elucidated with reference to the embodiments described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is an illustration of multi-function printer shown in accordance with aspects of the present disclosure.

FIG. 2 is a diagram of a protected system including a fleet of trusted devices shown in accordance with aspects of the present disclosure.

FIG. 3 is a block diagram illustrating the operation of a protected system including a fleet of trusted devices illustrated according to aspects of the present disclosure.

FIG. 4 is a block diagram illustrating a multi-function printer in accordance with aspects of the present disclosure.

FIG. 5A is a flowchart illustrating a computer-implemented method of coordinating threat detection and mitigation among a fleet of trusted devices in accordance with aspects of the present disclosure.

FIG. 5B is a flowchart illustrating a computer-implemented method of coordinating threat detection and mitigation among a fleet of trusted devices in accordance with further aspects of the present disclosure.

FIG. 5C is a flowchart illustrating a computer-implemented method of coordinating threat detection and mitigation among a fleet of trusted devices in accordance with still further aspects of the present disclosure.

### DETAILED DESCRIPTION OF EMBODIMENTS

The present disclosure is directed to systems and methods of coordinating threat detection and mitigation processes among a fleet of connected trusted multi-function devices. In accordance with various embodiments of the present disclosure, the systems and methods utilize a security information and event management solution in conjunction with a threat response profile tailored to the fleet of trusted devices in order to provide a coordinated threat response that can be narrowly and/or broadly applied to one or more devices of the fleet of trusted devices.

As described herein, a fleet of connected trusted devices refers to two or more electronic devices that are in communication with each other and that each possess a file sharing protocol used to safely share files or other data with one or more other devices within the fleet. In embodiments, this file sharing protocol can be utilized to set up, maintain, and/or otherwise operate the fleet of trusted devices. For example, one or more devices can be set up to share files automatically with one or more other devices of the fleet so that all devices in the fleet are set up the same way without further intervention by a user. More specifically, the file sharing protocol can enable device files to be shared across all devices within the fleet. In embodiments, files that may be shared can include, but are not limited to, software update files, encrypted configuration files, workflow template add-on files, user-content files, and/or the like.

In particular embodiments, two or more electronic devices may be grouped in a trust community to share files. A trust community is a group of devices that are securely connected with each other. These trusted devices can be connected through administrative credentials and may share a trust token that allows them to remain connected with each other. A tree topology is an example of one structure that can be used within a trust community to arrange the trusted devices to share files, although other topologies may be implemented.

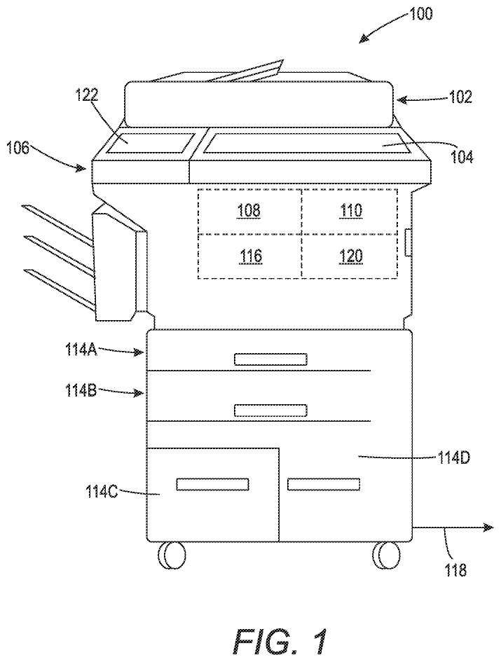

In embodiments, one or more of the electronic devices in a fleet of trusted devices can be multi-function devices (MFDs), such as multi-function printers (MFPs). Such devices combine the capabilities of photocopiers, printers, scanners and, optionally, fax machines in one unit, acting as a hub for many of the user's document processing needs. For example, with reference to FIG. 1, an exemplary multi-function device 100 that is a multi-function printer is illustrated in accordance with certain aspects of the present disclosure. The multi-function device 100 may be a printing apparatus of the type suitable for use with the present disclosure. In embodiments, the multi-function device 100 can utilize both hardware components and software to perform one or more tasks such as printing, scanning, faxing, copying, and/or file sharing. Put another way, the multi-function device 100 can provide one or more services, such as a printing service, a scanning service, a faxing service, a copying service, a file sharing service, and/or the like. In the example of FIG. 1, the multi-function device 100 comprises a document feeder 102, a user interface 104, an image reading device 106, an image forming device 108, a duplex unit 110, an output device 22, one or more paper cassettes 114A, 114B, 114C, 114D, and a controller 116 including one or more software components for controlling the device 100. The multi-function device 100 may be connected to a network via a network connection 118.

In embodiments, the multi-function device 100 may comprise one or more replaceable units 120, including but not limited to, ink or toner cartridges, a laser image forming apparatus (which may include an electric charging unit), a transfer unit, a fusing unit, one or more rollers or belts, and/or the like. Such replaceable units may comprise a customer replaceable unit motor (CRUM) unit or tag, the CRUM unit or tag being connected to and associated with the replaceable units within the multi-function device 100. Such CRUM unit or tag is not connected to the frame of the multi-function device 100. The frame of the multi-function device 100 is defined herein as the structural body of the multi-function device 100 that is not a replaceable unit. In some embodiments, a tag 122 is connected to and associated with the frame of the multi-function device 100, such that the identification tag 122 remains unaffected even as one or more replaceable units of the multi-function device 100 are replaced.

More specifically, in some embodiments, the multi-function device 100 may include a tag 122 that is a non-contact memory device arranged on the multi-function device 100. In some embodiments, the tag 122 can be hidden from view such that users would not know it was there unless previously instructed. The tag 122 may store information such as, but not limited to, the originally installed configuration (e.g., the output speed) of the device 100, a unique number associated with the device 100 (e.g., serial number), whether the device 100 is metered (i.e., does the customer pay by page and report the total pages printed with toner supplied by the manufacturer/reseller, or does the customer purchase toner as needed), customer information (i.e., like a customer asset tag), and/or the like. In some embodiments, the tag 122 can be an NFC tag (e.g., THIN FILM™ NFC OPENSENSE™ tags) operatively arranged to communicate with a computing device (e.g., an NFC tag reader). In other embodiments, the tag 122 can be a radio-frequency identification (RFID) tag operatively arranged to communicate with a corresponding computing device. In some embodiments, the tag 122 may also comprise information that can be read via an optical reader, for example, ultraviolet ink that is not visible to the human eye. However, it should be appreciated that the tag 122 may be implemented as any suitable stored memory device that can communicate information to a corresponding computing device via wired or wireless connection. It should be also appreciated that, while the present disclosure only illustrates the use of one tag, one or more tags may be used, including one or more types of tags 122.

As mentioned above, the multi-function device 100 can provide one or more services, such as a printing service, a scanning service, a faxing service, a copying service, a file sharing service, and/or the like. In embodiments, the controller 116 may be configured to provide one or more of these services. For example, in some embodiments, the controller 116 may be used to implement a printing path schedule based on one or more print orders. The multi-function device 100 may be capable of simplex and/or duplex output, in which a stream of images (or digital video signals representative of images) desired to be printed causes the desired images to be formed on a selected side of a print sheet.

In further embodiments, after one or more scanning/copying parameters may be entered via the user interface 104, the controller 116 may operate the document feeder 102 in order to convey a document to be scanned or copied to a predetermined reading position on image reading device 106. In particular embodiments, the image reading device 106 can illuminate the document conveyed to the reading position thereof, such that the resulting reflection from the document is transformed into a corresponding electric signal, or image signal, by a solid state imaging device (e.g., a Charge Coupled Device (CCD) image sensor). After the document has been read, the controller 116 may operate the multi-function device 100 to drive the document away from the reading position. In embodiments, the image forming device 108 can then form an image represented by the image signal on a printer substrate (or print media) by an electrophotographic (i.e., xerographic), thermosensitive, heat transfer, ink jet and/or similar system.

When providing a copying service, a printer substrate or print media may be fed from one or more paper cassettes 114A, 114B, 114C, 114D to the image forming device 108. In some embodiments, the duplex unit 110 may be operatively arranged to turn over the printer substrate carrying an image on one side of thereof and again feed it to the image forming device 108. As a result, an image can be formed on both sides of the printer substrate in order to complete a duplex copy.

Although certain services such as printing and copying services have been described herein, it should be appreciated that other services such as scanning, faxing, and file sharing may also be provided. For example, in the case of a scanning service, an image signal produced as described above may be digitally rendered into a file that can be transmitted (e.g., via the network connection 118) to another device, such as a remote server or directly to a user's computer. In particular embodiments, a fleet of trusted devices 100 may be established in order to coordinate or otherwise distribute one or more services. For example, in some embodiments, a fleet of trusted devices may include a first multi-function device that specializes in high-capacity printing jobs, a second multi-function device that specializes in scanning documents, and a plurality of multi-function devices configured to every-day printing, scanning, copying, faxing, and/or file sharing needs. These and other arrangements are possible in accordance with aspects of the present disclosure.

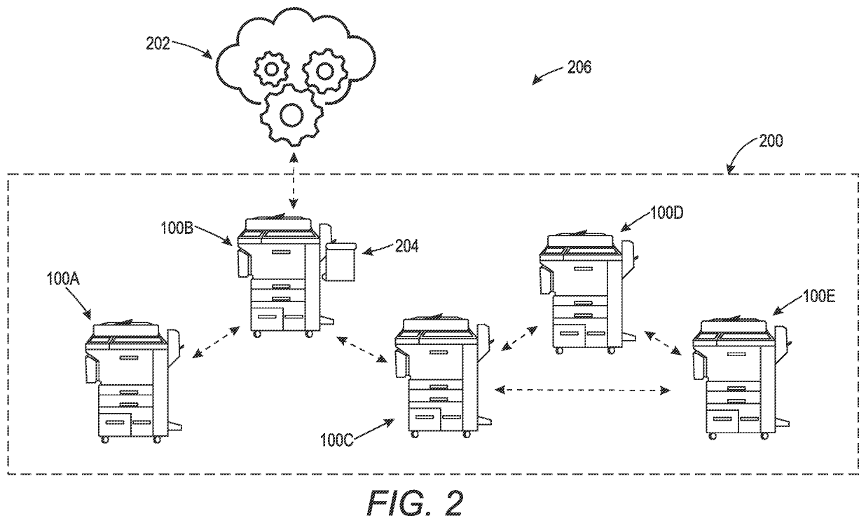

For example, with reference to FIG. 2, a fleet 200 of trusted devices 100A-100E is illustrated in accordance with certain aspects of the present disclosure. As described herein, the fleet 200 of trusted devices 100A-100E may be established through the sharing of administrative credentials and/or a trust token that allows each device 100A-100E to remain securely connected with each other. In particular embodiments, the trusted devices 100A-100E may be shared between a plurality of users such that a user may select one or more of the devices 100A-100E for a specific service. For example, the fleet 200 of trusted devices 100A-100E may be distributed across an organization's office building, and a user (not shown) may select device 100D to complete a printing service because it is the closest device among the fleet 200. However, it should be appreciated that the fleet 200 of trusted devices 100A-100E is not required to be within the same building, but may be distributed more broadly and securely connected remotely via wired and/or wireless network connections. In embodiments, each of the trusted devices 100A-100E can be a multi-function printer connected via wired and/or wireless network connections in accordance with a variety of possible topologies. As shown in the example of FIG. 2, device 100A is connected with device 100B, device 100B is connected with devices 100A, 100C, device 100C is connected with devices 100B, 100D, 100E, device 100D is connected with devices 100C, 100E, and device 100E is connected with devices 100C, 100D.

With further reference to FIG. 2, the fleet 200 of trusted devices 100A-100E may be connected to and/or in communication with a security information and event management (SIEM) service 202. In embodiments, the SIEM system 202 may be a cloud-based service operated by a service provider using one or more remote devices (e.g., remote servers). In other embodiments, the SIEM system 202 may be an on-premises service operated by an organization using one or more local devices (e.g., local servers). Regardless, the SIEM system 202 can be connected to and/or in communication at least one trusted device (e.g., device 100B) of the fleet 200. In specific embodiments, the SIEM system 202 is only connected to and/or in communication with one trusted device (e.g., device 100B) of the fleet 200, as shown in the example of FIG. 2. In embodiments, the SIEM system 202 may be connected to and/or in communication with a trusted device (e.g., device 100B) that possesses a threat response profile 204, as also shown in FIG. 2.

In embodiments, the SIEM system 202 can be configured to receive information related to the operation of the devices 100A-100E of the fleet 200, and to return key security-related messages to at least the device maintaining the threat security profile 204 (e.g., device 100B in the example of FIG. 2). As described herein, the fleet 200 of trusted devices 100A-100E, the SIEM system 202, and the threat response profile 204 hosted by at least one of the trusted devices (e.g., device 100B) may form a system 206 for coordinating threat detection and mitigation in accordance with various aspects of the present disclosure.

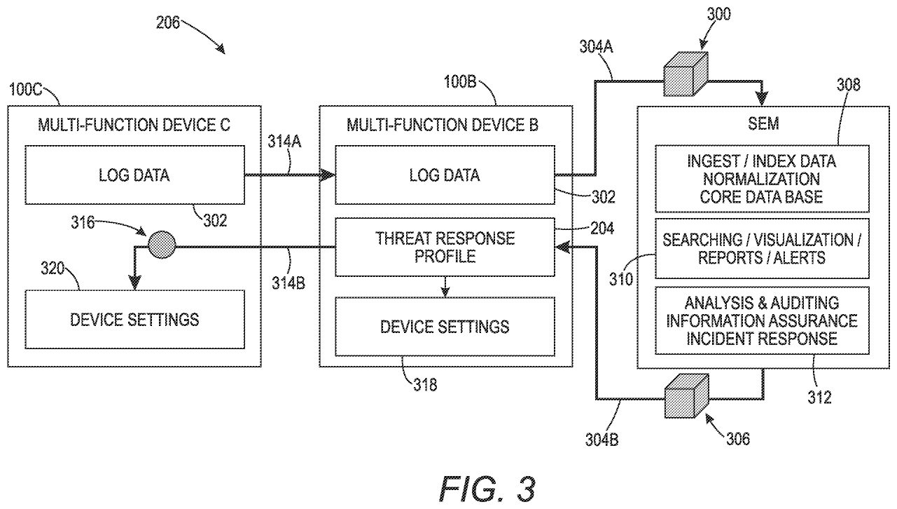

More specifically, with reference to FIG. 3, the operation of a system 206 for coordinating threat detection and mitigation is illustrated in accordance with certain aspects of the present disclosure. As shown, the system 206 includes an SIEM system 202 in communication with a first multi-function device 100B that comprises a threat response profile 204. In embodiments, the SIEM system 202 may receive one or more event reports 300 comprising log data 302 from at least the first multi-function device 100B via a wired and/or wireless network connection 304A. That is, each of the devices 100A-100E of the fleet 200 may be configured to collect and store a variety of log data 302 related to the operation of the corresponding device 100A-100E, which can then be transmitted to the SIEM system 202 for analysis. In embodiments, the log data 302 can include information related to device log-ins, information related to device firewall events, information related to IDS alerts, the number and type of job services requests and/or performed, and/or the like. In specific embodiments, the log data can include one or more of the following: the number of failed logins from a single device 100A-100E; the number of firewall-related events from a single IP address; the number of IDS alerts from a single IP address; and the detection of identifiable malware.

According to certain aspects of the present disclosure, the events reports 300 transmitted to the SIEM system 202 may include log data 302 from two or more devices 100A-100E of the fleet 200, including from a plurality of devices 100A-100E of the fleet 200. That is, in embodiments, the device in communication with the SIEM system 202 (e.g., multi-function device 100B) may receive log data 302 from one or more other trusted devices 100A-100E within the fleet 200 via a trusted network protocol 314A. In embodiments, the trusted network protocol 314A may enable routing of log data 302 between all of the devices 100A-100E of the fleet 200. As such, the events reports 300 sent to the SIEM system 202 may include log data 302 from each of the trusted devices 100A-100E of the fleet 200.

In embodiments, the system 206 may be configured such that the multi-function device 100B sends events reports 300 to the SIEM system 202 periodically, on a schedule, or upon demand based on the detection of certain log data 302. In further embodiments, the system 206 may be configured such that the SIEM 202 periodically requests an events report 300 from the multi-function device 100B, for example, based on an organization's preferred schedule.

In embodiments, the SIEM system 202 may analyze the log data 302 of one or more events reports 300 to determine one or more security-related messages 306, which can be transmitted to a device of the fleet 200 maintaining the threat response profile (e.g., multi-function device 100B) via wired and/or wireless network connection 304B. For example, a security-related message might include a determination of a possible or likely brute force attack detected in connection with one or more trusted devices 100A-100E. In another example, a security-related message might include a report or indication that malware was detected on a removable drive (e.g., a USB drive) inserted into one of the trusted devices 100A-100E. In still further examples, a security-related message might include a determination of a web-based attack, unauthorized use of the organization's system privileges, loss or theft of a device, ransomware, a DDOS attack, and/or the like. In embodiments, the wired and/or wireless network connection 304B may be the same or may be different from the wired and/or wireless network connection 304A.

More specifically, the SIEM system 202 can include one or more software components configured to process and analyze log data 302 of one or more events reports 300. In particular embodiments, the SIEM system 202 may be able to integrate with other security tools and technologies, including intrusion detection systems (IDS/IPS), firewalls, antivirus solutions, and threat intelligence feeds. In particular embodiments, as shown in FIG. 3, the SIEM system 202 can include: an input component 308 configured to process incoming data, normalize the data, and maintain a core database of information; a representation component 310 configured to search the incoming data and prepare visualizations, reports, and/or alerts based thereon; and an analysis and verification component 312 configured to analyze and audit the incoming data, perform information assurance, and provide incident responses.

In particular embodiments, the input component 308 can be configured to efficiently ingest and normalize data (e.g., log data, etc.) from various sources, such as servers, network devices, and applications, which may include parsing and structuring incoming data so that it can be effectively analyzed and correlated. In embodiments, the SIEM system 202 can be configured to monitor incoming data in real-time to identify security incidents or anomalies as they occur. The input component 308 can also be configured to store and manage log data over time, such as by maintaining a core database of information.

In embodiments, the representation component 310 can be configured to create visualizations and reports based on the analyzed data, which can provide insights into the security posture of the organization and help in making informed decisions.

In embodiments, the analysis and verification component 312 can be configured to correlate events and log entries to identify patterns and potential security risks. When suspicious activities or security violations are detected, the analysis and verification component 312 may generate alerts or notifications for further investigation. The analysis and verification component 312 may also be configured with customizable rules and policies such that security administrators can define specific rules, policies, and alerts based on their organization's specific security requirements. In embodiments, the analysis and verification component 312 may further be configured to provide guidance on how to mitigate threats, contain breaches, recover from security incidents, and support forensic analysis by allowing security professionals to trace back and investigate security risks.

In embodiments, at least one of the trusted devices 100A-100E of the fleet 200 connected to the SIEM system 202 may be configured to receive the security-related messages 306 from the SIEM system 202. In embodiments, the trusted device 100A-100E that receives the security-related messages 306 also maintains a threat response profile 204 for the fleet 200. For example, as shown in the example of FIGS. 2 and 3, the multi-function device 100B possesses the threat response profile 204 and is configured to receive the security-related messages 306 from the SIEM system 202.

As described herein, the threat response profile 204 maintained by at least one device 100B of a fleet 200 of trusted devices 100A-100E can be configured to map security-related messages 306 (e.g., SIEM response categories, etc.) to a specific threat response 316 for one or more devices 100A-100E of the fleet 200. In particular embodiments, the threat response profile 204 may map different security-related messages to changes in individual device settings or combinations of settings for one or a combination of devices 100A-100E within the fleet 200. For example, in specific embodiments, the threat response 316 generated for one or more trusted devices 100A-100E can include, but is not limited to, one or more of the following: an instruction to communicate a warning (e.g., to a user); an instruction to disable a device; an instruction to disable a service of a device; an instruction to re-route an assigned task/job to another device within the fleet; an instruction to change one or more security settings of a device; an instruction to change file integrity permissions; an instruction to escalate an existing threat response; an instruction to alert an administrator; and/or an instruction to request additional information (e.g., from a user or administrator).

Put another way, each device 100A-100E within the fleet 200 can have a plurality of individually-modifiable device settings, including but not limited to, settings enabling/disabling one or more available services, settings allowing the display of alerts or other messages, settings allowing the coordination of services across devices, settings related to security and file integrity, and setting related to receiving user input. In accordance with various embodiments of the present disclosure, the threat response profile 204 may generate a threat response 316 that modifies one or more settings of the devices 100A-100E within the fleet 200.

In particular embodiments, the threat response 316 generated based on the security-related messages 306 using the threat response profile 204 can include an instruction to disable one or more services of an affected device within the fleet 200 of trusted devices 100A-100E without discontinuing one or more other services of the affected device. For example, the security-related messages 306 may indicate a particular security threat affecting the faxing service of multi-function device 100B, and the threat response profile 204 may map this security-related message 306 to an instruction to disable the faxing service of the affected device (i.e., multi-function device 100B) without affecting one or more other services of the affected device (e.g., printing service, copying service, scanning service, file sharing service, etc.).

In embodiments, the device in communication with the SIEM system 202, such as multi-function device 100B in the example of FIG. 3, may be configured to distribute the generated threat response 316 to one or more other devices 100A-100E of the fleet 200 via the trusted network protocol 314B. In particular embodiments, the trusted network protocol 314B may be the same or different from the trusted network protocol 314A discussed above.

In exemplary embodiments, the threat response 316 generated by a first multi-function device 100B may include a unique or device-specific threat response 316 for one or more other multi-function devices 100A, 100C-100E of the fleet 200. Put another way, for example, the threat response 316 generated may include a first threat response for at least first device of the fleet 200 of trusted devices 100A-100E, a different second threat response for at least a second device of the fleet 200 of trusted devices 100A-100E, a different third threat response for at least a third device of the fleet 200 of trusted devices 100A-100E, and so on.

For example, in some embodiments, the security-related messages 306 received from the SIEM system 202 may indicate a particular threat involving unauthorized physical access to the location of one or more devices 100A-100E or to the devices themselves. As such, the threat response profile 204 may map the security-related messages 306 to a threat response that involves disabling all of the services of one or more devices that are located physically near the affected device(s), while leaving the services of devices located farther away and/or at a different location from the affected device(s) intact.

In embodiments, the threat response 316 generated using the threat response profile 204 can include a device-specific threat response that is customized based on a configuration of each device 100A-100E. In further embodiments, the threat response 316 generated using the threat response profile 204 can include an escalation and/or de-escalation of a threat level for one or more devices 100A-100E of the fleet 200.

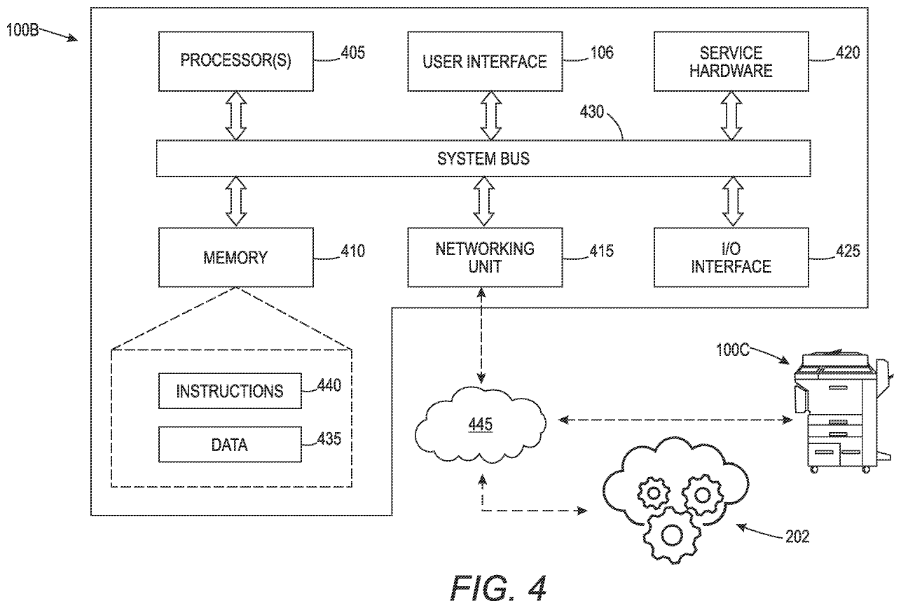

Turning to FIG. 4, the components of an electronic device 100B in a fleet 200 of trusted devices 100A-100E are illustrated in accordance with further aspects of the present disclosure. In embodiments, the electronic device 100B can be a multi-function printer having both hardware and software components for performing one or more tasks such as printing, scanning, faxing, copying, and/or file sharing. As shown in the example of FIG. 4, the electronic device 100B includes: one or more processors 405; machine-readable memory 410; a user interface 104; a networking unit 415; service hardware 420 for performing one or more of the services described above; and an input/output interface 425. One or more of the components of the electronic device 100B may be interconnected and/or communicate through a system bus 430 containing conductive circuit pathways through which instructions (e.g., machine-readable signals) may travel to effectuate communication, tasks, storage, and the like. As described above, the service hardware 420 of the electronic device 100B can include, but is not limited to, a document feeder 102, a user interface 104, an image reading device 106, an image forming device 108, a duplex unit 110, an output device 22, one or more paper cassettes 114A, 114B, 114C, 114D, and/or the like.

The one or more processors 405 may include one or more high-speed data processors adequate to execute the program components described herein and/or perform one or more steps of the methods described herein. The one or more processors 405 may include a microprocessor, a multi-core processor, a multithreaded processor, an ultra-low voltage processor, an embedded processor, and/or the like, including combinations thereof. The one or more processors 405 may include multiple processor cores on a single die and/or may be a part of a system on a chip (SoC) in which the processor 405 and other components are formed into a single integrated circuit, or a single package.

The input/output (I/O) interface 425 of the electronic device 100B may include one or more I/O ports that provide a physical connection to one or more devices, such as manufacturer diagnostic devices, user computing devices, and/or the like. Put another way, the I/O interface 425 may be configured to connect one or more peripheral devices of the device 100B in order to facilitate communication and/or control of between such devices. In some embodiments, the I/O interface 425 may include one or more serial ports.

The networking unit 415 of the electronic device 100B may include one or more types of networking interfaces that facilitate wireless communication between one or more components of the electronic device 100B and/or between the electronic device 100B and one or more external devices. In embodiments, the networking unit 415 may operatively connect the electronic device 100B to a communications network 445, which may include a direct interconnection, the Internet, a local area network (“LAN”), a metropolitan area network (“MAN”), a wide area network (“WAN”), a wired or Ethernet connection, a wireless connection, a cellular network, and similar types of communications networks, including combinations thereof. In some examples, electronic device 100B may communicate with one or more other trusted devices (e.g., device 100C), as well as an SIEM system 202, via the networking unit 415 and network 445.

The memory 410 of the electronic device 100B can be variously embodied in one or more forms of machine-accessible and machine-readable memory. In some examples, the memory 410 may include one or more types of memory, including one or more types of transitory and/or non-transitory memory. In particular embodiments, the memory 410 may include a magnetic disk storage device, an optical disk storage device, an array of storage devices, a solid-state memory device, and/or the like, including combinations thereof. The memory 410 may also include one or more other types of memory, such as dynamic random-access memory (DRAM), static random-access memory (SRAM), erasable programmable read-only memory (EPROM), electrically erasable programmable read-only memory (EEPROM), Flash memory, and/or the like.

In particular embodiments, the memory 410 can be configured to store data 435 and machine-readable instructions 440 that, when executed by the one or more processors 405, cause the electronic device 100B to perform one or more steps of the methods and/or processes described herein. Put another way, provided herein is a computer-readable storage medium 410 having stored thereon machine-readable instructions 440 to be executed by one or more processors 405, and one or more processors 405 configured by the machine-readable instructions 440 stored on the computer-readable storage medium 410 to perform one or more of the operations of the methods described herein. In an exemplary embodiment, the memory 410 of the electronic device 100B can be configured to store a threat response profile 204 as described above.

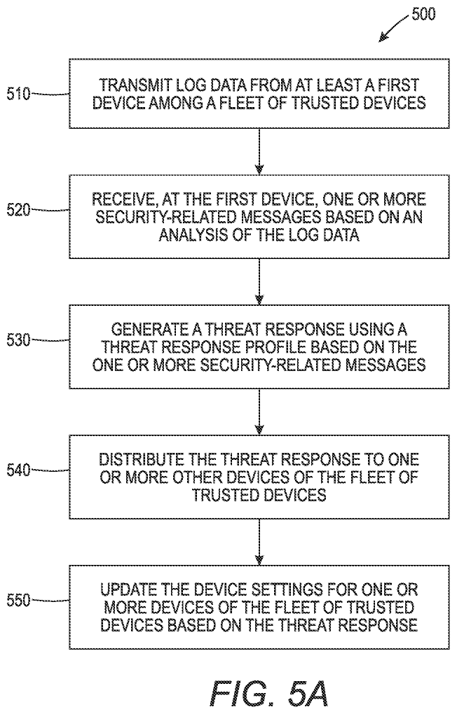

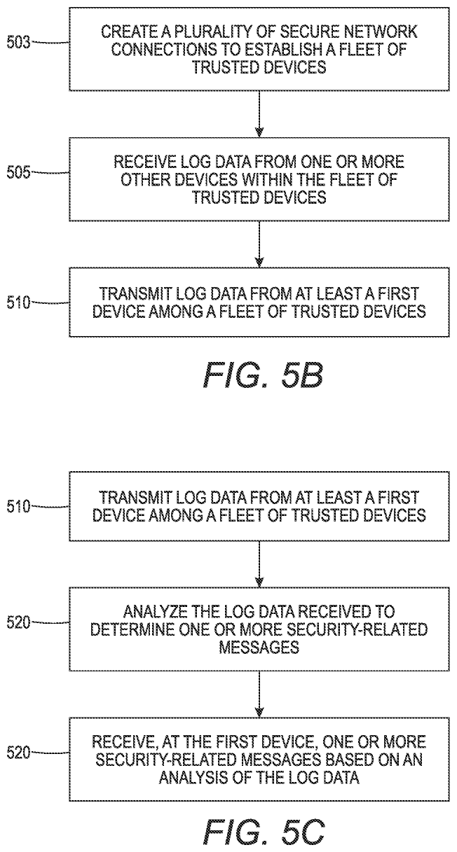

With reference to FIGS. 5A-5C, the present disclosure also describes computer-implemented methods 500 of coordinating threat detection and mitigation among a fleet 200 of trusted devices 100A-100E. In the example of FIG. 5A, the method 500 can include: in a step 510, transmitting an events report 300 comprising log data 302 from at least a first device of the fleet 200 of trusted devices 100A-100E to an SIEM system 202; in a step 520, receiving one or more security-related messages 306 based on an analysis of the events report 300; in a step 530, generating a threat response 316 based on the one or more security-related messages 306 using a threat response profile 204; in a step 540, distributing the generated threat response 316 to one or more other devices of the fleet 200 of trusted devices 100A-100E via one or more trusted connections (e.g., connections 314B); and in a step 550, changing a device configuration setting for one or more of the other devices of the fleet 200 of trusted devices 100A-100E based on the threat response 316 that is generated and distributed.

More specifically, in a step 510, the method 500 can include transmitting one or more events reports 300 from at least a first device (e.g., multi-function printer 100B) of a fleet 200 of trusted devices 100A-100E to an SIEM system 202. In embodiments, one or more events reports 300 can include log data 302 from one or more devices of the fleet 200 of trusted devices 100A-100E. Accordingly, as shown in FIG. 5B, it should be understood that prior to transmitting the one or more events reports 300, the method 500 can include: in a step 503, establishing a fleet 200 of trusted devices 100A-100E (i.e., by creating secure network connections between the devices 100A-100E); and in a step 505, receiving at the first device (e.g., device 100B) log data 302 from one or more of those other devices (e.g., devices 100A, 100C-100E) over the secure network connections (e.g., connections 314A). As described above, the first electronic device may be configured such that events reports 300 are sent to the SIEM system 202 periodically, on a schedule, or upon demand based on the detection of certain log data 302. In certain embodiments, the SIEM 202 can periodically request an events report 300 from the first electronic device, for example, based on an organization's preferred schedule. In embodiments, the events reports 300 may be transmitted to the SIEM system 202 via a communications network 445 employing one or more wired and/or wireless connections.

In a step 520, the method 500 can include receiving one or more security-related messages 306 from the SIEM system 202 based on an analysis of the events report 300. In embodiments, the one or more security-related messages 306 may be received by at least the first electronic device (e.g., device 100B) of the fleet 200 of trusted devices 100A-100E. It should be understood then that the SIEM system 202 receives the log data 302 from the first electronic device and processes/analyzes the log data 302 in order to generate the one or more security-related messages 306. Put another way, as shown in FIG. 5C, the method 500 can include, in a step 515, analyzing the log data 302 received from the first electronic device in order to determine one or more security-related messages 306.

In a step 530, the method 500 can include using a threat response profile 204 maintained by the first electronic device (e.g., device 100B) to generate a threat response 316 for the fleet 200 of trusted devices 100A-100E. the threat response profile 204 maintained by at least one device 100B of a fleet 200 of trusted devices 100A-100E can be configured to map security-related messages 306 (e.g., SIEM response categories, etc.) to a specific threat response 316 for one or more devices 100A-100E of the fleet 200. In embodiments, the threat response profile 204 maps different security-related messages to changes in individual device settings or combinations of settings for one or a combination of devices 100A-100E within the fleet 200. In specific embodiments, the threat response 316 generated for one or more trusted devices 100A-100E can include, but is not limited to, one or more of the following: an instruction to communicate a warning (e.g., to a user); an instruction to disable a device; an instruction to disable a service of a device; an instruction to re-route an assigned task/job to another device within the fleet; an instruction to change one or more security settings of a device; an instruction to change file integrity permissions; an instruction to escalate an existing threat response; an instruction to alert an administrator; and/or an instruction to request additional information (e.g., from a user or administrator).

In embodiments, the threat response 316 generated based on the security-related messages 306 using the threat response profile 204 can include an instruction to disable one or more services of an affected device within the fleet 200 of trusted devices 100A-100E without discontinuing one or more other services of the affected device. For example, the security-related messages 306 may indicate a particular security threat affecting the faxing service of multi-function device 100B, and the threat response profile 204 may map this security-related message 306 to an instruction to disable the faxing service of the affected device (i.e., multi-function device 100B) without affecting one or more other services of the affected device (e.g., printing service, copying service, scanning service, file sharing service, etc.). In further embodiments, the threat response 316 generated by a first device (e.g., device 100B) may include a unique or device-specific threat response 316 for one or more other multi-function devices 100A, 100C-100E of the fleet 200. Put another way, for example, the threat response 316 generated may include a first threat response for at least first device of the fleet 200 of trusted devices 100A-100E, a different second threat response for at least a second device of the fleet 200 of trusted devices 100A-100E, a different third threat response for at least a third device of the fleet 200 of trusted devices 100A-100E, and so on. The threat response 316 generated using the threat response profile 204 can also include a device-specific threat response that is customized based on a configuration of each device 100A-100E, and/or an escalation and/or de-escalation of a threat level for one or more devices 100A-100E of the fleet 200.

In a step 540, the method 500 can then include distributing the generated threat response 316 to one or more other devices of the fleet 200 of trusted devices 100A-100E via one or more trusted connections 314B established between the devices. For example, as described herein, the fleet 200 of devices 100A-100E are maintain a secured file sharing protocol that easily facilitates sharing of setting configuration files, including but not limited to a threat response file 316. Unlike in conventional systems, maintaining a fleet 200 of trusted devices 100A-100E ensures that a coordinated response can be distributed across multiple devices within the fleet 200 simultaneously, and streamlines the distribution process since the trusted connections are pre-established and maintained as part of the fleet configuration. As a result, there is no need to negotiate or establish new connections when distributing the threat response, thereby improving the ability of the system to respond to security threats in real-time. Additionally, this ability to provide real-time threat responses can be scaled efficiently when new trusted devices 100A-100E are added to the fleet 200.

In a step 550, the method 500 can include updating or otherwise changing a device configuration setting for one or more devices of the fleet 200 of trusted devices 100A-100E in accordance with the threat response 316 generated using the threat response profile 204. As mentions above, each device 100A-100E within the fleet 200 can have a plurality of individually-modifiable device settings, including but not limited to, settings enabling/disabling one or more available services, settings allowing the display of alerts or other messages, settings allowing the coordination of services across devices, settings related to security and file integrity, and setting related to receiving user input. Thus, the threat response profile 204 may generate a threat response 316 that individually and flexibly modifies one or more such settings of the devices 100A-100E within the fleet 200. In particular embodiments, the step 550 can include communicating a warning, disabling a device completely, disabling one or more individual services of a device, re-routing an assigned task/job to another device within the fleet 200 of trusted devices 100A-100E, changing a security setting (e.g., requiring login information), changing file integrity permissions, escalating and/or de-escalating an existing threat response, alerting an administrator, requesting additional information, and/or the like.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein, although the terms first, second, third, etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It should also be understood that, unless clearly indicated to the contrary, in any methods claimed herein that include more than one step or act, the order of the steps or acts of the method is not necessarily limited to the order in which the steps or acts of the method are recited.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, comprising an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, comprising a local area network (LAN) or a wide area network (WAN), or the connection can be made to an external computer (for example, through the Internet using an Internet Service Provider). In some examples, electronic circuitry comprising, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. A computer-implemented method of coordinating threat detection and mitigation among a fleet of trusted devices, the method comprising:
transmitting, from at least a first device of the fleet of trusted devices, an events report comprising log data from at least the first device of the fleet of trusted devices;
receiving, at the first device of the fleet of trusted devices, one or more security-related messages generated based on an analysis of the events report;
generating, via the first device of the fleet of trusted devices, a threat response based on the one or more security-related messages using a threat response profile;
distributing, from the first device, the generated threat response to one or more other devices of the fleet of trusted devices via one or more trusted connections between the devices of the fleet of trusted devices; and
for one or more of the other devices of the fleet of trusted devices, changing a device configuration setting for the device based on the threat response generated.

2. The computer-implemented method of claim 1, wherein each trusted device of the fleet of trusted devices is a multi-function printer.

3. The computer-implemented method of claim 1, wherein the events report is transmitted from at least the first device to a security information and event management system, and wherein the one or more security-related messages are received from the security information and event management system.

4. The computer-implemented method of claim 3, further comprising:
analyzing, via the security information and event management system, the events report transmitted from at least the first device to determine the one or more security-related messages.

5. The computer-implemented method of claim 1, wherein the threat response includes one or more of the following: an instruction to communicate a warning; an instruction to disable a device; an instruction to disable a service; an instruction to re-route an assigned task to another device within the fleet of trusted devices; an instruction to change security settings; an instruction to change file integrity; an instruction to escalate the threat response; an instruction to alert an administrator; and an instruction to request additional information.

6. The computer-implemented method of claim 1, wherein the threat response includes an instruction to disable one or more services of an affected device within the fleet of trusted devices without discontinuing one or more other services of the affected device.

7. The computer-implemented method of claim 6, wherein the one or more services includes at least one of a printing service, a scanning service, a faxing service, a copying service, and a file sharing service.

8. The computer-implemented method of claim 1, wherein the threat response includes (i) a first threat response for a first affected device of the fleet of trusted devices, and (ii) a second threat response for a second affected device of the fleet of trusted devices, wherein the first threat response is different from the second threat response.

9. The computer-implemented method of claim 1, wherein the threat response generated using the threat response profile includes a device-specific response for each device of the fleet of trusted devices, wherein each device-specific response is customized based on a configuration of each device.

10. The computer-implemented method of claim 1, wherein the log data of the events report includes one or more of the following: number of failed logins from a single device; number of firewall-related events from a single IP address; number of IDS alerts from a single IP address; and detection of identifiable malware.

11. The computer-implemented method of claim 1, wherein the events report includes log data collected from one or more devices of the fleet of trusted devices in addition to log data collected from the first device of the fleet of trusted devices.

12. A non-transitory computer-readable storage medium having stored thereon machine-readable instructions that, when executed by one or more processors, cause the one or more processors to perform operations comprising:
transmit, from at least a first device of a fleet of trusted devices, an events report comprising log data from at least the first device of the fleet of trusted devices;
receive one or more security-related messages generated based on an analysis of the events report;
generate a threat response based on the one or more security-related messages using a threat response profile; and
distribute the generated threat response to one or more other devices of the fleet of trusted devices via one or more trusted connections between the devices of the fleet of trusted devices.

13. The non-transitory computer-readable storage medium of claim 12, wherein each trusted device of the fleet of trusted devices is a multi-function printer.

14. The non-transitory computer-readable storage medium of claim 12, further comprising machine-readable instructions that cause the one or more processors to:
change a device configuration setting of one or more devices of the fleet of trusted devices based on the threat response generated.

15. The non-transitory computer-readable storage medium of claim 12, wherein the threat response includes one or more of the following: an instruction to communicate a warning; an instruction to disable a device; an instruction to disable a service; an instruction to re-route an assigned task to another device within the fleet of trusted devices; an instruction to change security settings; an instruction to change file integrity; an instruction to escalate the threat response; an instruction to alert an administrator; and an instruction to request additional information.

16. The non-transitory computer-readable storage medium of claim 12, wherein the threat response includes an instruction to disable one or more services of an affected device within the fleet of trusted devices without discontinuing one or more other services of the affected device.

17. The non-transitory computer-readable storage medium of claim 12, wherein the threat response includes (i) a first threat response for a first affected device of the fleet of trusted devices, and (ii) a second threat response for a second affected device of the fleet of trusted devices, wherein the first threat response is different from the second threat response.

18. The non-transitory computer-readable storage medium of claim 12, wherein the threat response generated using the threat response profile includes a device-specific response for each device of the fleet of trusted devices, wherein each device-specific response is customized based on a configuration of each device.

19. An electronic device configured to coordinate threat detection and mitigation within a fleet of trusted devices, the electronic device comprising:
one or more processors; and
a memory in communication with the one or more processors, wherein the memory comprises machine-readable instructions that, when executed by the one or more processors, cause the one or more processors to perform operations including the following:
generate and/or receive a threat response, wherein the threat response includes an instruction to change a device configuration setting for one or more devices within the fleet of trusted devices;
distribute the threat response to one or more other devices within the fleet of trusted devices; and
change a device configuration setting of the electronic device based on the threat response generated and/or received.

20. The electronic device of claim 19, wherein each trusted device of the fleet of trusted devices is a multi-function printer.

21. The electronic device of claim 20, wherein the instruction to change a device configuration setting for one or more devices within the fleet of trusted devices includes an instruction to disable one or more services of an affected device within the fleet of trusted devices without discontinuing one or more other services of an unaffected device, the one or more services including at least one of a printing service, a scanning service, a faxing service, a copying service, and a file sharing service.

22. The electronic device of claim 19, wherein the memory further comprises machine-readable instructions that, when executed by the one or more processors, cause the one or more processors to perform operations including the following:
transmit an events report to a security information and event management system, wherein the events report comprises log data from at least the electronic device;
receive, from the security information and event management system, one or more security-related messages generated based on an analysis of the events report; and
generate the threat response based on the one or more security-related messages using a threat response profile.

23. The electronic device of claim 22, further comprising a threat response profile stored within the memory of the electronic device, the threat response profile including a plurality of rules for interpreting one or more security-related messages received from the security information and event management system and generating a threat response for one or more devices of the fleet of trusted devices.

24. The electronic device of claim 19, wherein the threat response is received from at least a first device within the fleet of trusted devices via one or more trusted connections between the devices of the fleet of trusted devices.
